(19) United States
(12) Patent Application Publication
(10) Pub. No.: US 2003/0035521 A1
(43) Pub. Date: Feb. 20, 2003

(54) Key telephone system and main unit thereof

(75) Inventor: Seiji Tani, Fussa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/217,642

(22) Filed: Aug. 14, 2002

(30) Foreign Application Priority Data
Aug. 16, 2001 (JP) 2001-247267

(51) Int. Cl. H04M 1/64

(52) U.S. Cl. 379/88.22

(57) ABSTRACT

A soft key template table and a data template table are stored in both of a storage section of a main unit and a storage section of a voice mail server. The soft key template table and data template table are databases in which guidance messages to be displayed on a display of each key telephone are associated with corresponding numbers. Code information including template numbers is transmitted over a serial line. A conversion processing section converts the template number to a display message and causes the display to display the message.

### CROSS-REFERENCE TO RELATED APPLICATIONS

This application is based upon and claims the benefit of priority from the prior Japanese Patent Application No. 2001-247267, filed Aug. 16, 2001, the entire contents of which are incorporated herein by reference.

### BACKGROUND OF THE INVENTION

1. Field of the Invention

The present invention relates to a key telephone system and a main unit thereof. In particular, this invention relates to an improvement of a key telephone system including a server unit which provides voice mail services.

2. Description of the Related Art

A voice mail service is one of services that a key telephone system has. With this service, a user can hear anytime over a telephone line a voice message stored in a voice mail server.

In order to retrieve or delete a message from the voice mail server, the user has to operate the key telephone. In conventional systems, the user is informed of contents of key operations of the telephone by voice guidance. Consequently, there is a possibility of an erroneous operation due to mishearing. In addition, if the number of operation items is large, an operational tree becomes complex and much time is consumed to hear voice guidance. Owing to these shortcomings, the voice mail service may rather become inconvenient.

Moreover, if the functions of the voice mail server are upgraded, the exchange and telephones in the system need to be upgraded accordingly. Thus, much cost and labor are required for system alterations, and the expansion of functions of the system is not easy.

Prior art relating to this kind of system is disclosed in Jpn. Pat. Appln. KOKAI Publication No. 7-193633. This document discloses a system wherein display data is sent from a voice mail unit (VM) to a display-equipped telephone via a LAN (Local Area Network), and character information is displayed on the telephone.

As has been described above, in the conventional key telephone system, the contents of key operations are instructed to the user by voice guidance. Consequently, there is a possibility of mishearing, and the system is not necessarily convenient for users. Furthermore, in the conventional key telephone system, large-scale upgrading is necessary for expansion of functions, and thus the expansion of functions is not easy.

### BRIEF SUMMARY OF THE INVENTION

The object of the present invention is to provide a key telephone system and a main unit thereof, which can prevent erroneous operations due to mishearing of operational guidance and can make easier the expansion of operations.

According to the present invention, there is provided a key telephone system comprising: a terminal device (e.g. key telephone) having a plurality of operation keys (e.g. soft keys and numeral keys); a main unit connected to the terminal device over a extension line (e.g. call line); and a server unit (voice mail server) connected to the main unit over a data communication line (e.g. serial line or LAN) and providing services requested by operation of the operation keys to the terminal device. The server unit includes: first storage means (e.g. storage section 35) which stores a data table (e.g. soft key template table ST or data template table DT) in which a plurality of pieces of message information relating to the service are associated with predetermined code information; service providing means (e.g. service provision processing section 34a) which provides the services to the terminal device by selecting the message information corresponding to the service requested by the terminal device; first conversion means (e.g. conversion processing section 34b) which converts the message information selected by the service provision means to corresponding code information, referring to the data table stored in the first storage means; and first reporting means (e.g. code send-out processing section 34c) which reports to the main unit the code information obtained by the first conversion means over the data communication line. The main unit includes: second storage means (e.g. storage section 26) which stores the data table; second conversion means (e.g. conversion processing section 25a) which converts the code information reported from the server unit to the corresponding message information, referring to the data table stored in the second storage means; and second reporting means (e.g. relay processing section 25b) which reports to the terminal device the message information obtained by the second conversion means over the extension line. The terminal device includes output control means (e.g. display control section) which causes the display to display the message information reported from the main unit.

In the present invention, the terminal device includes a display (e.g. LCD (Liquid Crystal Display) and output control means (e.g. display control section) which causes the display to display the message information reported from the main unit.

With the above means, code information sent from the server unit is converted to message information such as a guidance message in the main unit. The obtained guidance message is displayed on the display of the terminal device. In other words, the key operation content for operating the server unit is displayed on the display. Thus, the user can surely operate the server unit without error.

In the present invention, the server unit includes transmission control means (e.g. download processing section) which transmits the data table stored in the first storage means to the main unit, for example, when the main unit is activated, thereby storing the data table in the second storage means.

When the server unit is upgraded, the operation contents of the terminal device are added or altered, and the data table is updated. The updated data table is stored in the main unit by download from the server unit. Thus, when the server unit is upgraded, large-scale system alterations, such as re-setting of operational procedures of operation keys in each terminal device, are needless. Therefore, it is possible to provide a key telephone system and a main unit thereof, which permit easy expansion of functions.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows the structure of a key telephone system according to an embodiment of the present invention;

FIG. 2 is a block diagram showing the structures of a main unit 20 and a voice mail server 30 shown in FIG. 1;

FIG. 3 is a schematic view of soft key template table ST shown in FIG. 2;

FIG. 4 is a schematic view of data template table DT shown in FIG. 2;

FIG. 5 is a block diagram showing the structure of a key telephone (11-1n) shown in FIG. 1;

FIG. 6 illustrates a sequence of operations of the key telephone system shown in FIG. 2;

FIG. 7 illustrates a sequence of operations, which follows the sequence shown in FIG. 6; and

FIGS. 8A, 8B and 8C show examples of display on a display 40 of the key telephone 11.

### DETAILED DESCRIPTION OF THE INVENTION

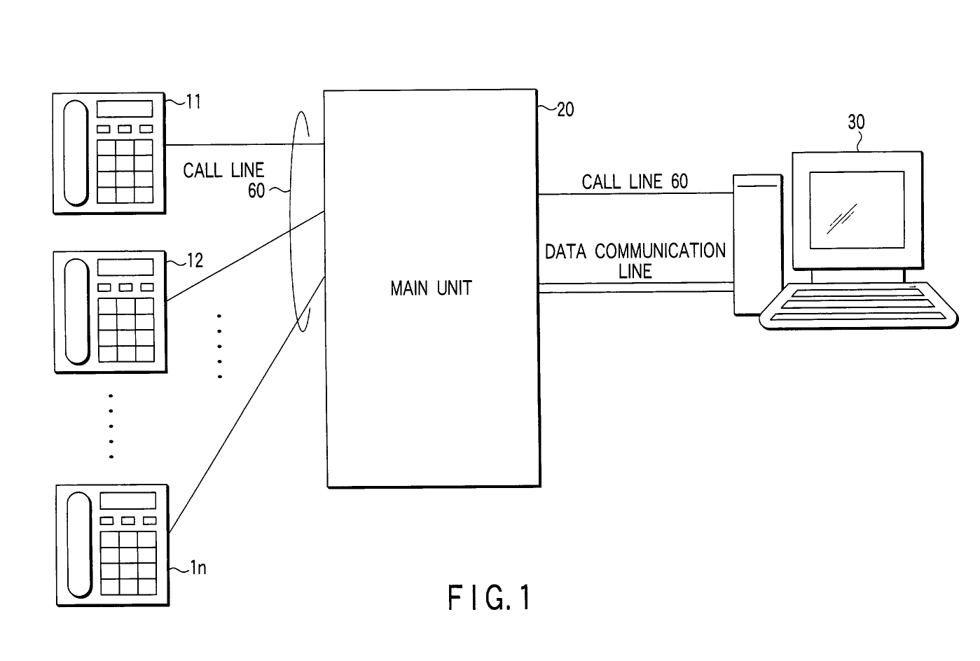

FIG. 1 shows the structure of a key telephone system (or a voice mail system) according to an embodiment of the present invention. This system comprises a plurality of key telephones 11-1n, a main unit 20, and a voice mail server 30 connected to the main unit 20. Each of key telephones 11-1n has a display and soft keys. The key telephones 11-1n are connected to the main unit 20 over call lines 60. The main unit 20 and voice mail server 30 are connected over a call line 60 and bidirectional data communication lines. The bidirectional data communication lines include a serial line such as RS232C, and a LAN (Local Area Network).

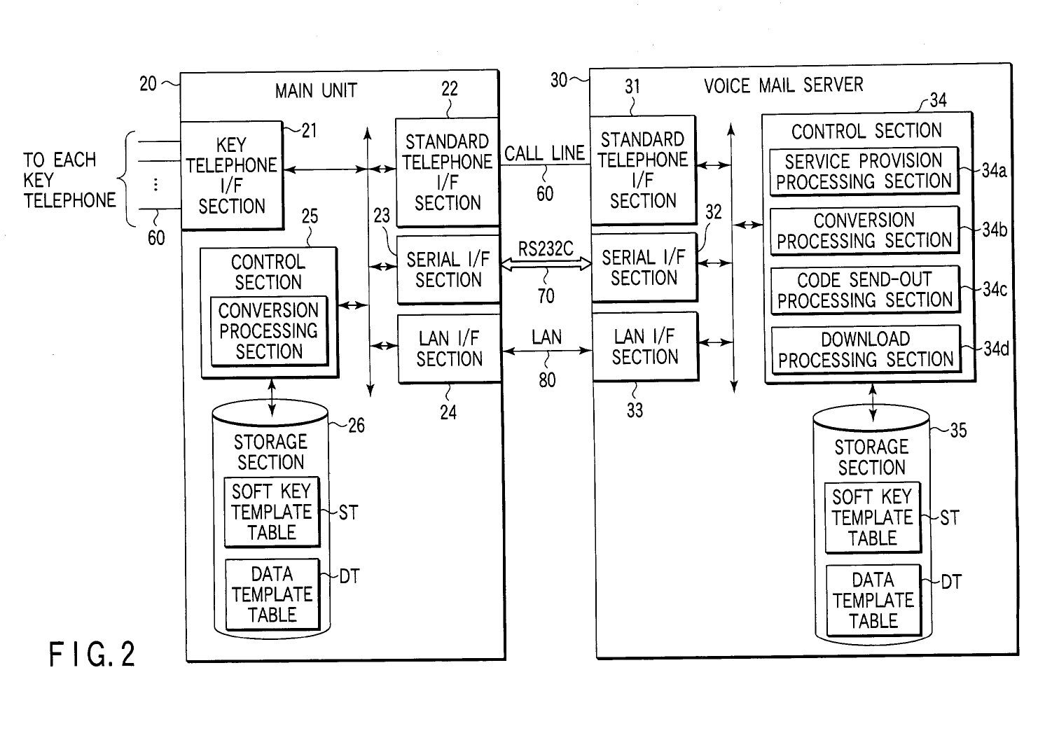

FIG. 2 is a block diagram showing the structures of the main unit 20 and voice mail server 30 shown in FIG. 1. The main unit 20 comprises a key telephone interface (I/F) section 21, a standard telephone interface (I/F) section 22, a serial interface (I/F) section 23, a LAN interface (I/F) section 24, a control section 25, and a storage section 26.

The key telephones 11-1n are connected to the key telephone I/F section 21 over call lines 60. The standard telephone I/F section 22 is connected to the call line 60. The serial I/F section 23 is connected to a serial line 70. The LAN I/F section 24 is connected to a LAN 80. The storage section 26 stores a soft key template table ST and a data template table DT at predetermined memory areas.

The voice mail server 30 comprises a standard telephone I/F section 31, a serial I/F section 32, a LAN I/F section 33, a control section 34 and a storage section 35. The standard telephone I/F section 31 is connected to the call line 60. The serial I/F section 32 is connected to the serial line 70. The LAN I/F section 33 is connected to the LAN 80. The storage section 35 stores a soft key template table ST and a data template table DT at predetermined memory areas. The soft key template table ST and data template table DT stored in the storage section 35 have the same contents as the soft key template table ST and data template table DT stored in the storage section 26 of main unit 20.

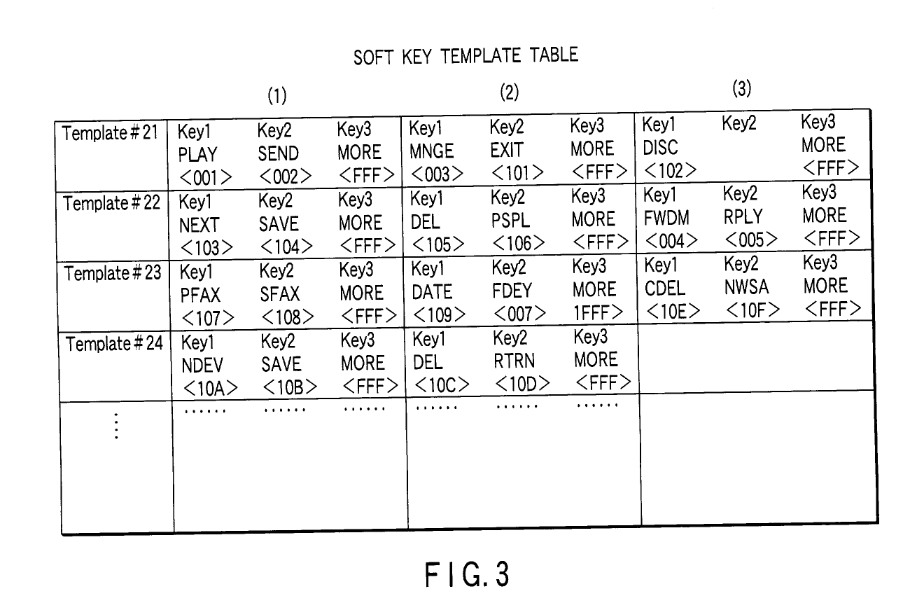

FIG. 3 is a schematic view of the soft key template table ST. The soft key template table ST is a table on which prompts (PLAY, SEND, MORE, etc.) to be displayed on the display of each key telephone (11-1n) are associated with numbers #21, #22, etc. which distinguish the respective templates. The prompts are displayed in association with soft keys (Key 1, Key 2, Key 3) of each key telephone 11-1n .

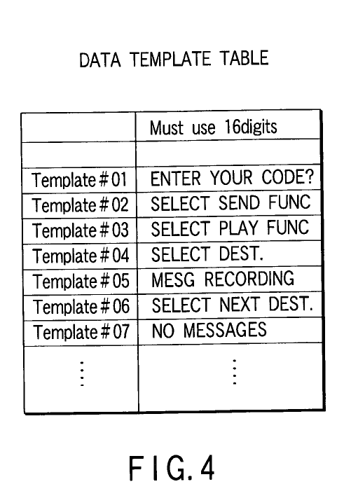

FIG. 4 is a schematic view of the data template table DT. The data template table DT is a table on which display messages (“ENTER YOUR CODE?”, etc.) to be displayed on the display of each key telephone (11-1n) are associated with numbers #01, #02, etc. which distinguish the respective templates. In the description in this specification, the prompts and display messages are generally referred to as guidance messages.

The soft key template table ST and data template table DT are databases in which message information items relating to services, which are to be provided to the key telephones 11-1n by the voice mail server 30, are associated with code information items that can distinguish the message information items.

In this embodiment, character-base data (i.e. data in character display format) is stored in the soft key template table ST and data template table DT. The reason is that each key telephone, 11-1n, is provided with the display. If the system includes a key telephone not equipped with a display, voice-base data (i.e. data in voice format audible by users) may be stored in each template table.

The control section 25 of main unit 20 shown in FIG. 2 has functions relating to communication controls for communication with the key telephones 11-1n and communication with the voice mail server 30, and also has a conversion processing section 25a and a relay processing section 25b. The conversion processing section 25a converts code information sent from the voice mail server 30 to a prompt or a display message corresponding to a template number. Specifically, the conversion processing section 25a converts the template number to a guidance message to be displayed on the display. In this case, the conversion processing section 25a refers to the soft key template table ST and data template table DT.

In addition, the conversion processing section 25a converts the content of a key operation effected on the key telephone to code information corresponding to a template number, by referring to the soft key template table ST and data template table DT.

The code information in this context means a format of data transmitted between the main unit 20 and voice mail server 30 via the serial line 70 or LAN 80. A communication protocol such as SMDI (Simplified Message Desk Interface) or a higher-function version thereof may be used for communication between the main unit 20 and voice mail server 30.

The relay processing section 25b informs the destination key telephone of a prompt or a display message generated by the conversion processing section 25a. In addition, the relay processing section 25b informs the voice mail server 30 of the code information generated by the conversion processing section 25a.

On the other hand, the control section 34 of voice mail server 30 comprises, in addition to various control functions, a service provision processing section 34a, a conversion processing section 34b, a code send-out processing section 34c and a download processing section 34d. The service provision processing section 34a interprets the key operation content corresponding to the code information delivered from the main unit 20, referring to the soft key template table ST and data template table DT. The service provision processing section 34a provides a service corresponding to the key operation content to the user of the key telephone. The service in this context refers to various functions relating to the voice mail service, such as hearing (playing) of a voice mail and deletion of a voice mail. In addition, when the service is to be provided to the key telephone, the service provision processing section 34a selects a prompt and a guidance message which is required according to the situation.

The conversion processing section 34b converts the prompt and guidance message selected by the service provision processing section 34a to the code information, referring to the data template table DT. The code send-out processing section 34c delivers the code information generated by the conversion processing section 34b to the main unit 20 over the serial line 70 or LAN 80. When the main unit 20 is activated, the download processing section 34d downloads the soft key template table ST and data template DT, which are stored in the storage section 35, into the main unit 20, thereby storing them in the storage section 26 of main unit 20.

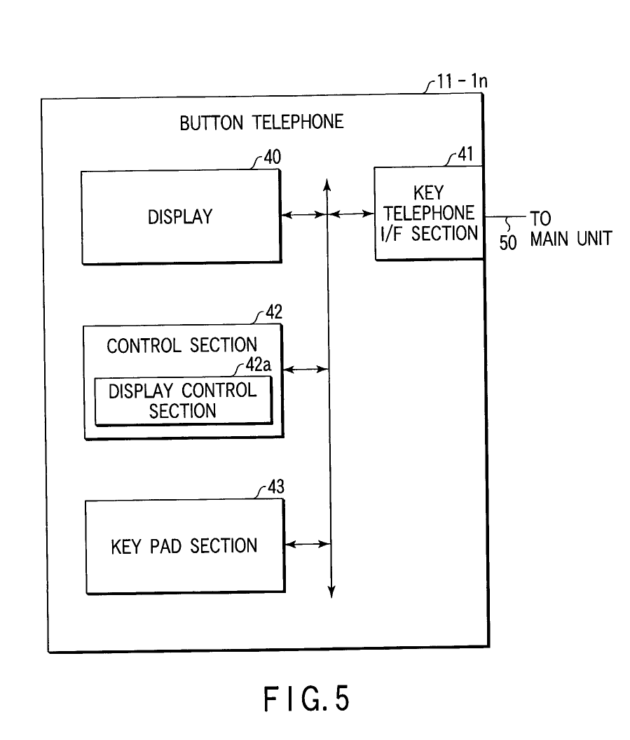

FIG. 5 is a block diagram showing the structure of the key telephone 11 shown in FIG. 1. The key telephones 12-1n have the same structure as the key telephone 11. The key telephone 11 comprises a key telephone interface (I/F) section 41, a display 40, a control section 42 and a key pad section 43. The key telephone I/F section 41 is connected to the main unit 20 over the call line 60, and performs an interface process for information communication between the key telephone 11 and main unit 20.

The display 40 is realized, for example, as an LCD (Liquid Crystal Display), and visually displays various messages. The key pad section 43 has soft keys and numeral keys and accepts user's input operations. The control section 42 includes a display control section 42a. The display control section 42a causes the display 40 to display various information delivered from the main unit 20.

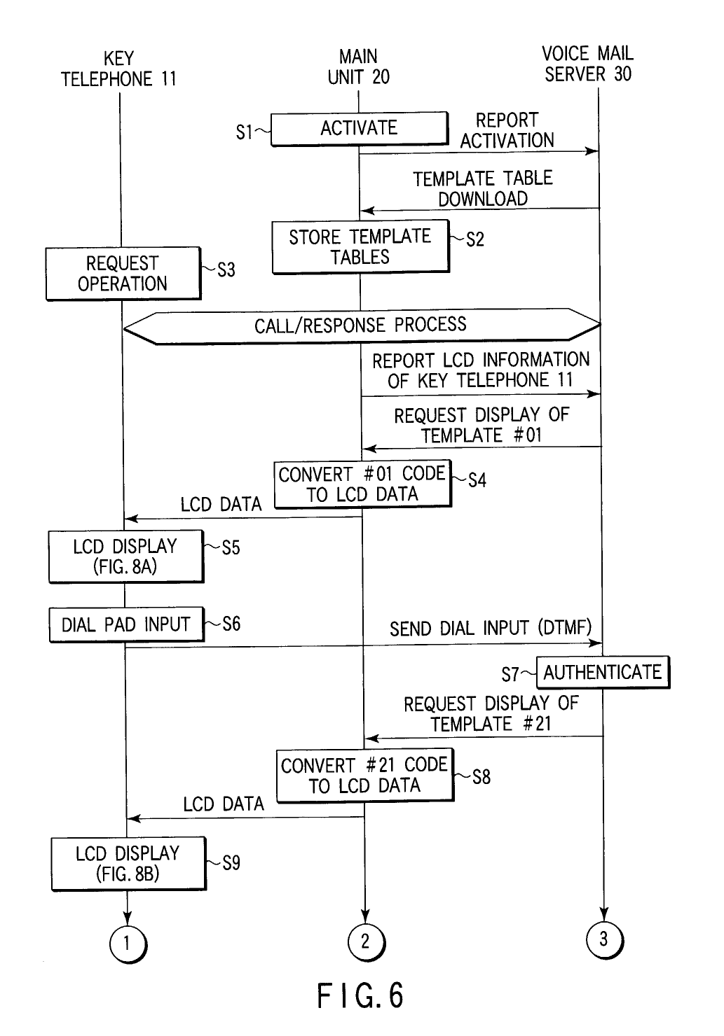

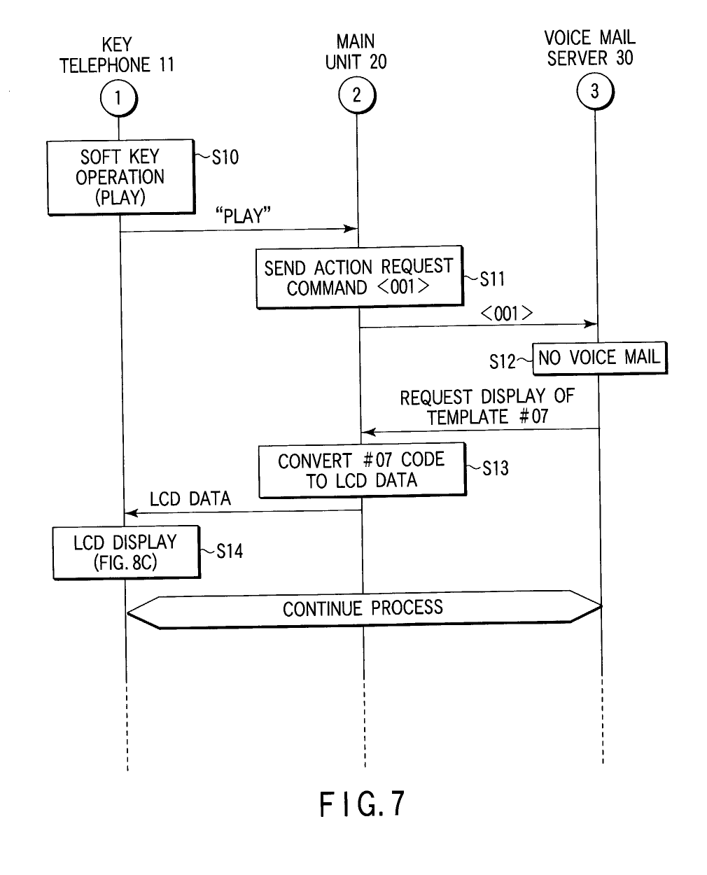

FIGS. 6 and 7 illustrate sequences of operations in the system having the above-described structure. In FIG. 6, when the main unit 20 is activated (step S1), the activation is reported to the voice mail server 30. The voice mail server 30 sends the soft key template table ST and data template table DT into the main unit 20 over the LAN 80, thereby storing them in the storage section 26 (step S2). The communication protocol used on the LAN is, for example, SNMP (Simple Network Management Protocol).

Assume that the user of key telephone 11 has called the voice mail server 30 in order to operate the voice mail server 30 (step S3). A call/response process is carried out between the key telephone 11 and voice mail server 30. Then, according to a predetermined command or control information, LCD information of key telephone 11 is reported to the voice mail server 30.

The voice mail server 30 sends a data screen output request command to the main unit 20. This command includes template number #01 as code information. That is, the voice mail server 30 requests that the content corresponding to template #01 should be displayed on the display 40 of key telephone 11.

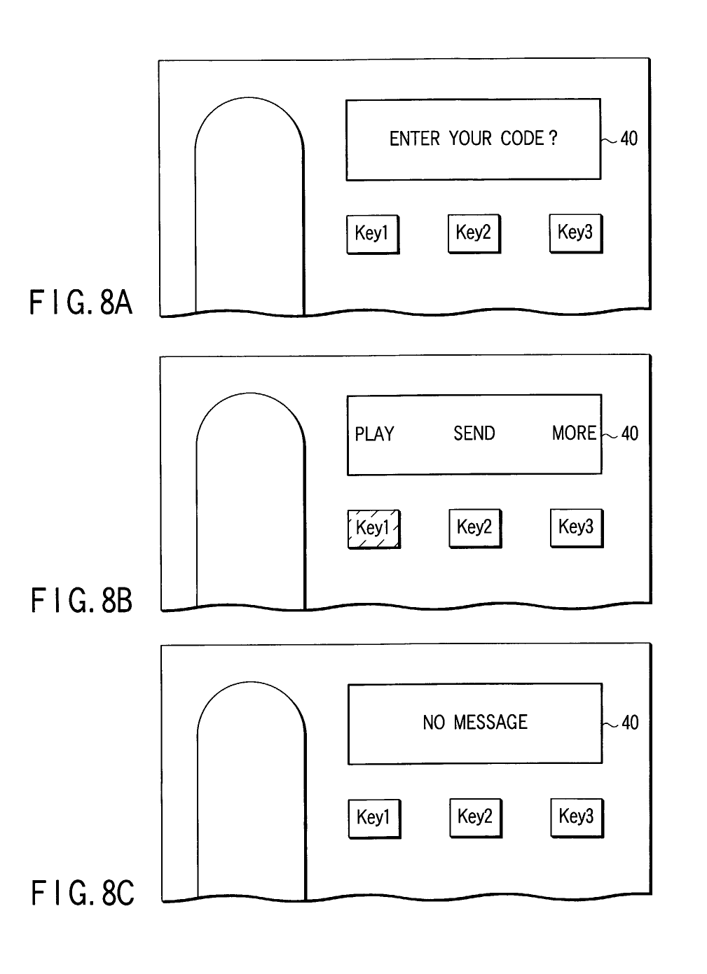

The main unit 20 converts the received code to LCD display data (step S4) and causes the display 40 of key telephone 11 to display the display data. Template #01 corresponds to “ENTER YOUR CODE?”. Thus, as shown in FIG. 8A, the display 40 displays message “ENTER YOUR CODE?” (step S5). This message means “Please input your password.”

The user of key telephone 11 reads the message and inputs the security code through the key pad section 43 of key telephone 11 according to the content of the message (step S6). The input content is sent to the voice mail server 30 via the standard telephone I/F section 22 by a DTMF (Dual Tone Multiple Frequency) signal.

The voice mail server 30 that has received the security code authenticates the security code and determines the validity (step S7). The voice mail server 30 then sends a soft key display request command to the main unit 20. This command includes template #21.

The main unit 20 that has received this command causes the display 40 of key telephone 11 to display the prompt corresponding to template #21 (step S8). Specifically, the content shown in FIG. 8B is displayed (step S9). FIG. 8B shows the content in box (1) of template #21 in FIG. 3. If “MORE” (corresponding to soft key “Key 3”) is depressed, box (2) of template #21 is displayed. The depression of “MORE” cyclically changes the display content among boxes (1) to (3) of the same template.

Assume that “PLAY” (corresponding to soft key “Key 1”) has been depressed in FIG. 7 (step S10). Then, the main unit 20 detects the depression and converts the code number <001> corresponding to “PLAY” in soft key template table ST to an action request command. This command is sent to the voice mail server 30 in the form of code information (step S11).

The voice mail server 30 that has received the code information analyzes the information in the command and executes a control corresponding to the analysis result. In the flow chart of FIG. 7, it is determined that no voice mail message is stored in the voice mail server 30 (step S12). Then, the voice mail server 30 sends to the main unit 20 a request to display template number #07. Upon receiving the request, the main unit 20 causes the display 40 of key telephone 11 to display message “NO MESSAGE” corresponding to template #07 (step S13). FIG. 8C shows the display content on display 40 at this stage. Similar operations are repeated hereafter.

As has been described above, in the present embodiment, the soft key template table ST and data template table DT are stored in both the storage section 26 of main unit 20 and the storage section 35 of voice mail server 30. The soft key template table ST and data template table DT are databases wherein guidance messages to be displayed on the display 40 of the key telephone, 11-1n, are formed as templates in association with the corresponding numbers. In this embodiment, the code information including the template number is transmitted over the serial line 70. The conversion processing section 25a converts the template number to a display message. The display control section 42a causes the display 40 to display the message. Thereby, the operation content of the voice mail server 30 is visually indicated to the user of the key telephone.

Compared to the system in which operation contents are indicated by voice guidance, the possibility of erroneous recognition of operation contents by users is greatly decreased. Thus, a convenient system with low possibility of erroneous operation can be provided.

In this embodiment, the display message in the form of code information is transmitted between the main unit 20 and voice mail server 30 over the data communication line such as serial line 70. Thus, the traffic over the data communication line can minimized, and more key telephones can be connected to the main unit 20.

In the embodiment, the soft key template table ST and data template table DT are downloaded from the voice mail server 30 into the main unit 20. Thereby, the same template data is stored in both units. Even if the functions of the voice mail server 30 are upgraded, the extension of functions of the system can easily be effected by downloading the updated soft key template table ST and data template table DT into the main unit 20 once again.

Therefore, a key telephone system can be provided wherein erroneous operations due to mishearing of operational guidance can be prevented and the extension of functions can easily be effected.

The system of this embodiment differs from that of the above-mentioned Jpn. Pat. Appln. KOKAI Publication No. 7-193633 with respect to the following points. In the system of this document, the storage means for storing data is provided in the voice mail unit alone. Besides, the system of this document has no means for converting code information to data. Thus, in the system of the document, display data itself is transferred over the LAN. By contrast, in the present embodiment, the code information is transferred. Thus, in this embodiment, the traffic over the serial line 70 and LAN 80 can be reduced, and the advantages, which the system of the above document does not have, can be obtained.

The present invention is not limited to the above embodiment. For example, in this embodiment, the soft key template table ST and data template table DT are stored in both the main unit 20 and voice mail server 30. The soft key template table ST and data template table DT stored in the main unit 20 are downloaded from the voice mail server 30. Alternatively, a purpose-specific storage unit may be separately provided in the system. Each template table may be stored in the separate storage unit and may be downloaded in the main unit 20 and voice mail server 30.

The timing of downloading the soft key template table ST and data template table DT into the main unit 20 is not limited to the time when the main unit 20 is activated.

In the present embodiment, voice-base data as well as character-base data may be stored in the soft key template table ST and data template table DT. Additionally, the display control section 42a may be provided with a function of outputting voice. In this case, the code information is converted to voice data in the conversion processing section 25a, and thus a voice operation guidance is output from the key telephone without a display. Thereby, key telephones without displays and key telephones with displays can be included in the same system. In other words, the system of this embodiment can be constructed by adding key telephones with displays to a conventional system. Accordingly, the cost for introducing the present system can be minimized.

An operation guidance cannot be displayed on the key telephone without a display, and thus there remains a possibility of mishearing of the guidance. However, if the system is provided with the structure wherein both template tables are downloaded from the voice mail server 30 into main unit 20, the other object of the present invention, i.e. “to enhance the extension of functions”, can be achieved.

Other modifications may be made without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A key telephone system comprising:
a terminal device having a plurality of operation keys;
a main unit connected to the terminal device over a extension line; and
a server unit connected to the main unit over a data communication line and providing services requested by operation of the operation keys to the terminal device,
wherein in that said server unit includes:
first storage means which stores a data table in which a plurality of pieces of message information relating to the service are associated with predetermined code information;
service providing means which provides the services to the terminal device by selecting the message information corresponding to the service requested by the terminal device;
first conversion means which converts the message information selected by the service provision means to corresponding code information, referring to the data table stored in the first storage means; and
first reporting means which reports to the main unit the code information obtained by the first conversion means over the data communication line, and
said main unit includes:
second storage means which stores the data table;
second conversion means which converts the code information reported from the server unit to the corresponding message information, referring to the data table stored in the second storage means; and
second reporting means which reports to the terminal device the message information obtained by the second conversion means over the extension line.

2. A key telephone system according to claim 1, wherein said second conversion means converts a content of a key operation, which has been executed in the terminal device on the basis of the message information reported to the terminal device, to the corresponding code information, referring to the data table stored in the second storage means,
said second reporting means reports the code information obtained by the second conversion means to the server unit over the data communication line, and
said service providing means interprets the a service content corresponding to the code information reported from the second reporting means by referring to the data table stored in the first storage means, and provides the corresponding service to the terminal device.

3. A key telephone system according to claim 1, wherein said terminal device includes:
a display; and
output control means which causes the display to display the message information reported from the main unit.

4. A key telephone system according to claim 1, wherein said output control means outputs as voice information the message information reported from the main unit.

5. A key telephone system according to claim 1 or 2, wherein said server unit includes transmission control means which transmits the data table stored in the first storage means to the main unit, thereby storing the data table in the second storage means.

6. A key telephone system according to claim 5, wherein said transmission control means transmits the data table stored in the first storage means to the main unit when the main unit is activated.

7. A key telephone system according to claim 1 or 2, wherein at least one of said plurality of pieces of message information includes operation guidance information for the operation keys.

8. A key telephone system according to claim 1 or 2, wherein at least one of said plurality of operation keys is a soft key, an operation content of which is variable according to a message displayed on the display in association with the operation key, and
said data table includes soft key template data in which a plurality of operation contents designated to the soft key are associated with predetermined code information.

9. A key telephone system according to claim 1 or 2, wherein said server unit is a voice mail server which provides a voice mail service to the terminal device.

10. A main unit provided in a key telephone system comprising a terminal device having a plurality of operation keys; said main unit connected to the terminal device over a extension line; and a server unit connected to the main unit over a data communication line and providing services requested by operation of the operation keys to the terminal device,
wherein said server unit includes:
first storage means which stores a data table in which a plurality of pieces of message information relating to the service are associated with predetermined code information;
service providing means which provides the services to the terminal device by selecting the message information corresponding to the service requested by the terminal device;
first conversion means which converts the message information selected by the service provision means to corresponding code information, referring to the data table stored in the first storage means; and
first reporting means which reports to the main unit the code information obtained by the first conversion means over the data communication line, and
wherein said main unit includes:
second storage means which stores the data table;
second conversion means which converts the code information reported from the server unit to the corresponding message information, referring to the data table stored in the second storage means; and
second reporting means which reports to the terminal device the message information obtained by the second conversion means over the extension line.
